(19) United States
(12) Patent Application Publication
(10) Pub. No.: US 2004/0032426 A1
(43) Pub. Date: Feb. 19, 2004

(54) System and user interface for adaptively presenting a trend indicative display of patient medical parameters

(76) Inventors: Jolyn Rutledge, Amesbury, MA (US); Amy M. Manetta, North Billerica, MA (US); Judith Shaffer, Orchard Park, NY (US)

Correspondence Address: Jack J. Schwartz & Associates, Suite 1507, 1350 Broadway, New York, NY, 10018-7702, US

(21) Appl. No.: 10/410,560

(22) Filed: Apr. 9, 2003

Related U.S. Application Data
(60) Provisional application No. 60/374,909, filed on Apr. 23, 2002.

(51) Int. Cl. G09G 5/00

(52) U.S. Cl. 345/764

(57) ABSTRACT

A system automatically selects and adapts a Flowsheet for trend indicative display of patient parameters in response to patient relocation to a different care unit and provides a preview image window indicating Flowsheet appearance in response to user entered configuration data. A system provides a user interface presenting patient medical parameter data in a trend indicative display indicating a time period comprising patient parameter acquisition time intervals. The system includes an acquisition processor for acquiring, from a patient monitoring device, data representing a parameter of a particular patient. The system also includes a selection processor for selecting a template display form from a predetermined plurality of template display forms associated with a corresponding plurality of different care units in response to a determined type of the acquired patient parameter. A data processor generates data representing a trend indicative display of the acquired patient parameter within the selected template display form.

This is a non-provisional application of provisional application serial No. 60/374,909 by J. Rutledge et al. filed Apr. 23, 2002.

### FIELD OF THE INVENTION

This invention is related to adaptively processing and displaying of medical information, and more particularly to processing and displaying patient medical data for user configurable display in a network environment.

### BACKGROUND OF THE INVENTION

Patient medical parameter data is acquired, collated, stored and displayed for use in providing patient clinical care in hospitals, clinics, and other healthcare delivery settings. Patient medical parameter data may include vital signs ventilator information, infusion pump data associated with fluid delivery and other data. Such patient medical parameter data is typically displayed on a patient monitoring device screen in a trend indicative chart with a time axis. This type of chart is commonly termed a Flowsheet. A patient monitoring device is usually located at a patient bedside or nursing station in a hospital ward or in an intensive care, surgical or other location and may be connected to a network such as the Internet, a LAN, a WAN or an intra-net for acquiring patient parameter data from local sources (e.g., patient attached sensors) or remote sources (e.g., a remotely stored electronic patient record). The Flowsheet is an electronic chronological chart of patient information that substitutes for a paper vital sign Flowsheet.

It is desirable that an electronic Flowsheet offer similar or better features and flexibility than a paper Flowsheet chart that it replaces. Such paper Flowsheet charts are used by hospital healthcare personnel, for example, to record patient Fluid Intake and Output information in many different ways. Paper Flowsheet layout is typically proprietary to an individual hospital and comprises printed forms used by healthcare personnel to create a patient record. Advantages of use of paper forms in a Flowsheet include consistency and flexibility. A nurse is able to write and incorporate text as desired in data fields of such a paper form. In contrast, known systems that provide an electronic Flowsheet offer limited capabilities. Specifically, some known systems constrain a user to employ a single template Flowsheet selected at time of patient admission to a hospital, for example. This initial Flowsheet template is later customized for the particular patient as needed using a complex configuration user interface. Further, known systems lack immediate and interactive Flowsheet preview capability permitting a user to preview a Flowsheet following user selection of configuration features. Consequently, known systems are typically non user-friendly and provide different Flowsheet records for different patients. The resultant electronic Flowsheets employed are inconsistent and also fail to replicate the look, features and flexibility of Flowsheet paper charts. A system according to invention principles addresses these limitations and derivative problems.

### SUMMARY OF THE INVENTION

A system automatically selects and adapts a Flowsheet for trend indicative display of patient parameters in response to patient relocation to a different care unit (e.g., a hospital department) and provides a preview image window indicating Flowsheet appearance in response to user entered configuration data. A system provides a user interface presenting patient medical parameter data in a trend indicative display indicating a time period comprising patient parameter acquisition time intervals. The system includes an acquisition processor for acquiring, from a patient monitoring device, data representing a parameter of a particular patient. The system also includes a selection processor for selecting a template display form from a predetermined plurality of template display forms associated with a corresponding plurality of different care units in response to a determined type of the acquired patient parameter. A data processor generates data representing a trend indicative display of the acquired patient parameter within the selected template display form.

### BRIEF DESCRIPTION OF THE DRAWINGS

In the drawing:

FIG. 1 is a block diagram of a communication network with various devices, according to the principles of the invention.

FIG. 2 represents a flowchart of a method for providing a user interface, according to the present invention.

FIGS. 3-10 show user interface display images supporting a user in configuring a user interface system to automatically select and adapt a Flowsheet for trend indicative display of patient parameters in response to patient relocation to a different care unit, according to the present invention.

FIG. 11 show a configured Flowsheet trend indicative display of acquired patient parameters, according to the present invention.

FIG. 12 represents a flowchart of a method for providing display images supporting configuration of a trend indicative display, according to the present invention.

FIG. 13 is a block diagram of a server having functionality in accordance with the present invention.

### DETAILED DESCRIPTION

The inventors have advantageously recognized that it is desirable to provide a digital Flowsheet that is both structured and flexible and to provide a mechanism permitting user determination of a desired structure in a straightforward manner. For this purpose, a user friendly interface system automatically selects and adapts a Flowsheet for trend indicative display of patient parameters in response to patient relocation to a different care unit. A care unit as used herein comprises a unit in any clinical care setting (e.g., a hospital, clinic, physician office, imaging center etc) for hosting a patient for care purposes for any duration (minutes, weeks or longer). The system also provides a preview image window indicating Flowsheet appearance immediately in response to user entered configuration data. Thereby advantageously eliminating the need for a user to imagine the prospective look and feel of a Flowsheet resulting from user entered configuration data. The system further enables a user to configure a Flowsheet template form through discrete, non-complex tasks.

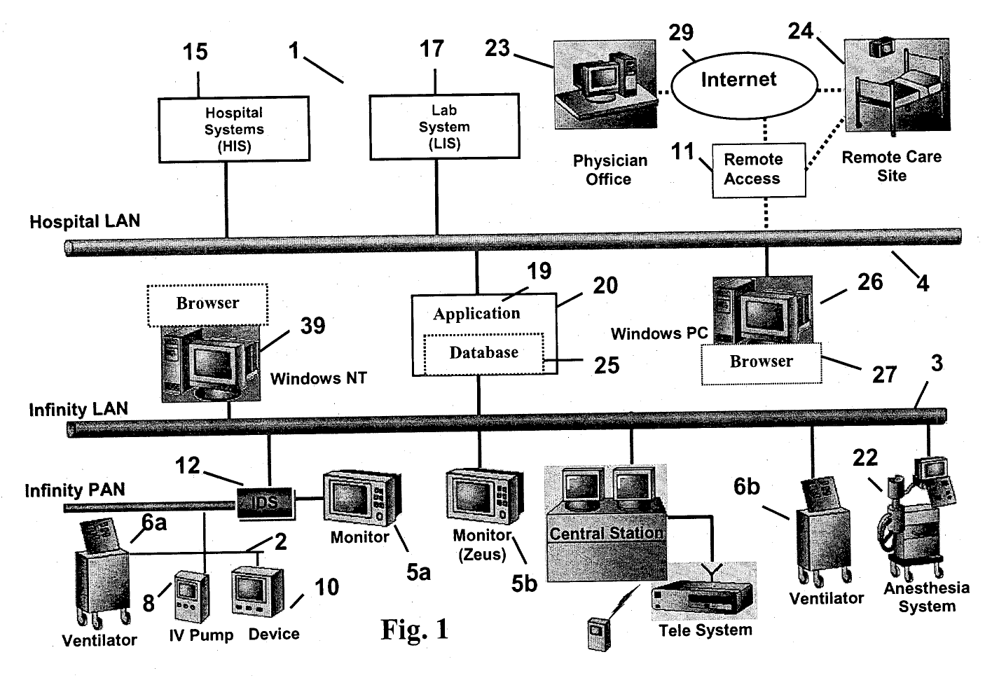

FIG. 1 is an exemplary block diagram of a communication network incorporating server 20 hosting executable application 19 providing a trend indicative user interface display of patient parameters (termed a Flowsheet) within identified acquisition time intervals. A Flowsheet may display different types of parameters associated with, for example, Intra-Venous fluids, drip administered medications, blood products, blood pressure, ventilation, vital signs, blood oxygen concentration, and infusion pump fluid delivery. Particular parameters contain different pieces of data that are important to describe a particular fluid. Further, hospitals typically employ different practices concerning the data to be included with each parameter and the manner of displaying this data. A Flowsheet generation system according to invention principles advantageously automatically selects and adapts a Flowsheet upon patient relocation to a different care unit and facilitates customization of a Flowsheet using a preview image window.

In an alternative embodiment, the executable application providing the Flowsheet user interface may be resident in another processing device in any part of the network shown in FIG. 1. Communication network 1 (FIG. 1) is represented by an IP (Internet Protocol) compatible network with a hierarchy of local area and wide area networks interconnected together. It is to be noted that although the present exemplary hospital or medical network is an IP compatible network, other types of networks such as, but not limited to optical or wireless networks, using other computing protocols such as, but not limited to, for example, X.25, frame relay, IBM SNA etc., may also be used, as one skilled in the art can readily appreciate. In addition, although the exemplary network described is a hierarchical network, this is not required by the present invention. Any type of network architecture that provides communication connectivity among the devices on the network may be used.

As shown In FIG. 1, the first level of the exemplary hierarchical network 1 comprises a Medical Interface Bus (MIB) 2. A MIB is a well-known medical industry standard for locally connecting medical devices together. As shown in FIG. 1, MIB 2 is typically used to interconnect medical devices in a care unit such as a patient's room within a nursing station to administer care to a particular patient and to monitor the particular patient. Various medical devices may be connected via MIB 2; examples shown in FIG. 1 comprise a ventilator 6a, IV (Intravenous) Pump 8 or other medical equipment 10. MIB 2 is typically connected to a second level LAN network 3 through an Interface Docking Station (IDS) device 12, for interfacing to Ethernet-compatible LAN network 3. The LAN 3 may be for example, an Infinity LAN, marketed by Siemens Medical System. This higher-level LAN 3 is typically, though not necessarily, used by other care units such as a particular department within a hospital, such as an intensive care unit or surgery unit, etc., depending on the size of the organization.

Although not shown in FIG. 1, more than one MIB may be connected to the second level LAN 3, so that more than one patient may be monitored or provided with care through LAN 3. In addition, medical devices may be connected directly to higher-level LAN 3. For example, as shown in FIG. 1, a ventilator 6b and an anesthesia system 22 are connected directly to LAN 3, without use of a MIB. Furthermore, LAN 3 may be interconnected to a Hospital LAN backbone 4 which also is Ethernet compatible. This backbone network 4 provides communication connectivity between various departments within a hospital or medical organization; for example, connecting hospital administrative systems 15 together with laboratory systems 17. In addition, the Hospital LAN 4 has a remote access gateway 11 which provides remote, secured access from, for example, a remote doctor's office 23 or a remote care site 24, to the various systems and devices on network 1, through for example, Internet 29. Alternatively, a remote site may also access the remote access gateway 19 directly through, for example, a dial-up telephone port, ADSL, or other types of private connection. Remote access gateway 11 may also be part of server 20, to be described below, instead of standing alone, as well know in the art.

According to the principles of the present invention, executable application 19 (or multiple applications in another embodiment) resides on central server on LAN 3 for gathering and processing data from the peripheral medical devices or facilities coupled to LAN 3 or hospital LAN 4, including laboratory results supplied via laboratory system 17 connected through an HL7 interface, for example. Additional medical parameter data including additional laboratory results acquired from any number of medical devices such as those shown in FIG. 1 may be obtained by server 20 using ASTM messaging, for example. The acquired medical parameters associated with a given patient, including laboratory test results, are acquired from the medical devices on network 1 for display and control on monitors 5a, 5b or PCs 26 and 39 or any other display hosting device at any level of the FIG. 1 network. One skilled in the art can readily recognize that server 20 may reside at any level of the hierarchy of network 1, since all the different levels of LANs (e.g., 3, or 4), as well as remote sites in FIG. 1 are interconnected. An example of server 20, is a Prometheus server, marketed by Siemens Medical System. The server may be hosted, for example, by a computer system that is capable of running Microsoft NT operating system.

Application 19 provides a user interface trend indicative display of patient parameters (a Flowsheet) covering a time period comprising user selectable acquisition time intervals. A user selectable acquisition time interval represented by a column in the Flowsheet covers a time period (typically 3 minutes to 4 hours or another user selectable range) in which patient parameters are acquired. Application 19 automatically filters acquired patient parameter data by selecting a patient parameter value for display in a Flowsheet column representing an individual acquisition time interval. Specifically, the selected patient parameter value is incorporated in an Internet compatible (web based) Flowsheet column representing the individual acquisition time interval. Application 19 advantageously enables a user to customize the Flowsheet trend indicative display of an individual patient parameter. Application 19 automatically selects and adapts a Flowsheet upon patient relocation to a different care unit and facilitates customization of a Flowsheet using a preview image window.

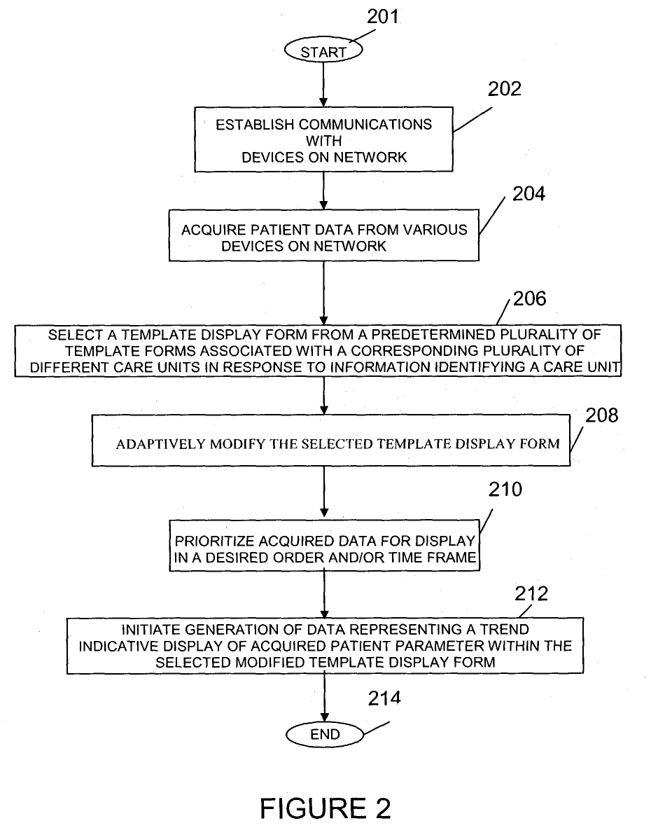

FIG. 2 shows in flow chart form, functions that are performed by executable application 19. Application 19 establishes communication with devices on the network as shown in step 202 after the start at step 201. This is done, for example, by using IP protocol and the known IP device address for each device on the network 1 (FIG. 1), in conjunction with any higher application-layer protocols, as well known in the art. Once communication is established between server 20 and the other devices, application 19, in step 204, starts to acquire parameters that are being monitored, laboratory results and settings selected for the various devices. As previously mentioned, laboratory results may be obtained through an HL7 interface with LIS 17, or via ASTM or MIB point of care (POC) medical devices depicted in FIG. 1. Types of acquired patient parameter include, blood pressure parameters, respiratory or ventilation parameters, vital sign parameters, blood oxygen concentration representative parameters, infusion pump parameters associated with fluid delivery, drip medication related parameters and other fluid related parameters, for example.

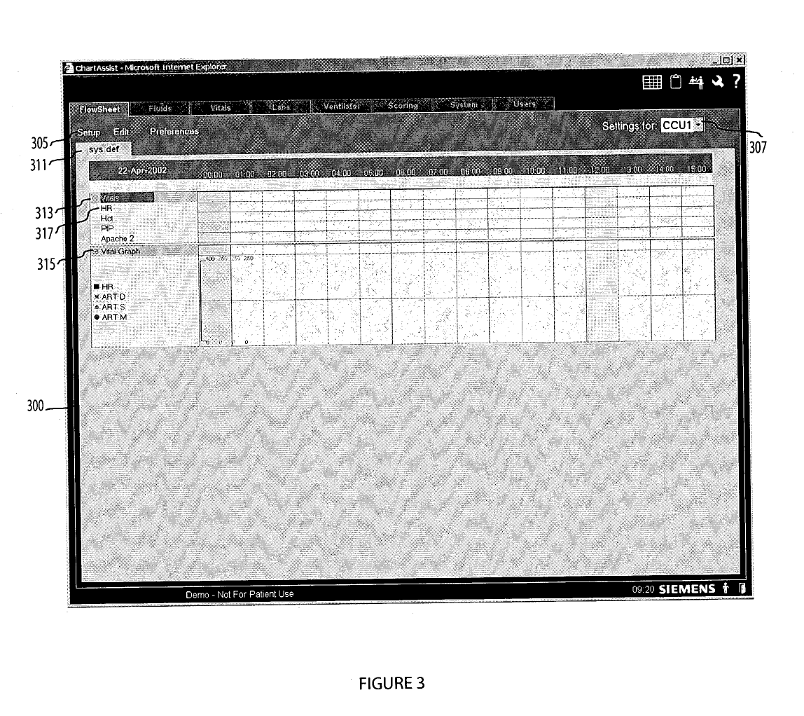

Medical data and laboratory results may be continuously, periodically or non-periodically acquired and correlated with a given patient for storage in relational data base 25 within server 20. Data base 25 may be of the type used for storing relational data such as the Microsoft SQL server. In addition, application 19 may obtain patient parameter data and patient data comprising medical laboratory results that are first entered and stored, for example, in laboratory system 17 of FIG. 1. Also, application 19 may acquire healthcare provider entered medical notes for display. At step 206, application 19 automatically selects a template display form from a predetermined plurality of template display forms associated with a corresponding plurality of different care units in response to information identifying a care unit. An exemplary template display form (discussed in more detail later) for displaying acquired patient parameters in a trend indicative display is illustrated in FIG. 3. Application 19 advantageously provides different setup template Flowsheet forms for different care units.

Upon patient arrival at a hospital the patient is admitted and assigned to a particular care unit. The hospital admission triggers the storage of a copy of a setup template Flowsheet form for the patient. The copy of the template Flowsheet determines the display format and allocation of storage of acquired patient parameters. Application 19 detects movement of the patient to a different care unit based on a change in the care unit advertised by the bed through the name service and stores a copy of the template Flowsheet identified as being for use in the new care unit in a record associated with the patient concerned. The patient parameters that are acquired in the new care unit are determined by the copy of the template Flowsheet. However, the displayed Flowsheet format is adaptively selected to match a parameter acquisition time period selected by a user for display. Thereby a user is able to scroll and view acquired patient parameters for an entire patient length of stay in a hospital and to see the parameter information in the same display format previously selected.

Application 19 derives information identifying a care unit by determining a number and type of parameters acquired in step 204. Application 19 can change a care unit when a bed advertises a different care unit through a name service. Alternatively, when a bed is not attached to a network or a patient is not attached to a monitor, i.e. a patient is not associated with an advertising bed, and is therefore not advertising the care unit can be changed manually by a user on Application 19.

Alternatively, application 19 detects movement of the patient to a different care unit based on a change in the parameters being acquired in the new care unit and stores a copy of the template Flowsheet identified as being for use in the new care unit in a record associated with the patient concerned. Specifically, application 19 determines the number and type of parameters acquired in step 204 from one or more of, (a) message data associated with a particular patient parameter, (b) a characteristic of a signal conveying an acquired patient parameter, (c) a characteristic of an acquired patient parameter and (d) data identifying a source of an acquired patient parameter. In another embodiment application 19 obtains information identifying a care unit from received message data. This message data is associated with acquired patient parameter data and is either derived from a patient monitoring device in a particular care unit or is manually entered by healthcare personnel. Alternatively, the message data is derived as part of a handshaking routine initiated upon attachment of probes from a user to a patient monitoring device in a new care unit. An identified care unit comprises a hospital department or other clinical care setting environment such as, an intensive care unit, a critical care unit, a surgical unit, an examination unit, a physiotherapy unit, an emergency unit, an imaging unit, an obstetrics/gynecology unit, a pediatric unit, a preventive care unit or a radiology unit, for example. Application 19 further uses a received patient identifier to automatically select a particular form associated with a corresponding particular patient from multiple forms associated with the identified care unit.

In step 208, application 19 adaptively modifies the selected template display form in response to predetermined attributes (including format determination data or configuration data of a trend indicative display) associated with the type of acquired patient parameters determined in step 206. A predetermined attribute associated with an individual acquired patient parameter at least one of, (a) identifies whether the acquired patient parameter data is to be displayed, (b) determines display settings of the trend indicative display, (c) identifies the care unit of the plurality of different care units, (d) identifies a particular patient and associates a predetermined trend indicative display format characteristic with the particular patient or (e) identifies a time period comprising patient parameter acquisition time intervals to be used by the trend indicative display format. At step 210, application 19, in response to a user command, prioritizes and stores acquired patient data in server 20, in a desired order and/or time frame for display. Application 19 in step 212 generates data representing a trend indicative display of prioritized acquired patient parameters within the modified template display form.

In one aspect of the present invention, a user may use a Microsoft Windows compatible PC 26 or Windows NT compatible PC 39 as shown in FIG. 1, or any other processing devices capable of running a menu generating program such as a web browser program (e.g., Microsoft Internet Explorer or Netscape Navigator, etc.) to view a Flowsheet, medical parameters and laboratory results information associated with a given patient. That is, a user may use a web browser on any processing device, as long as a communication connection can be made to server 20 and application 19, to make requests and view information acquired and stored in data base 25. This is advantageous, since a doctor may for example, gain access to a Flowsheet or laboratory test results from, for example, a remote physician's office 23, without having to access a dedicated terminal. Of course, a user can simply use a keyboard and/or a mouse or any other user interface devices to enter a user selection or request on a user computer, as is known in the art. Application 19 is therefore capable of collating and formatting medical data to be compatible with, for example, HTML (HyperText Mark-up Language) programming language for displaying data on a web browser. Application 19 is also responsive to, for example, HTTP (HyperText Transfer Protocol) commands originated from a user's web browser for making a request. The process of FIG. 2 ends at step 214.

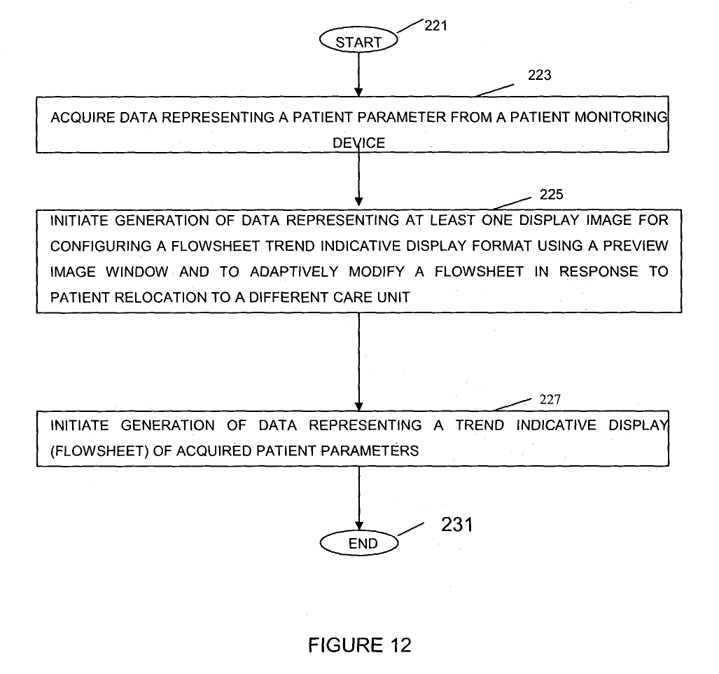

FIG. 12 represents a flowchart of a method for configuring a user interface system to automatically select and adapt a Flowsheet for trend indicative display of patient parameters in response to patient relocation to a different care unit. In step 223, following the start at step 221, application 19 acquires data representing a patient parameter from a patient monitoring device in the manner previously described in connection with FIG. 1. Application 19 in step 225 initiates generation of data representing multiple user interface images illustrated in FIGS. 3-10. The images enable a user to configure a Flowsheet trend indicative display format and to adaptively modify the Flowsheet in response to patient relocation to a different care unit The display images include a preview image window advantageously indicating Flowsheet appearance immediately in response to user entered configuration data. The system further generates composite images including one or more configuration image windows together with the template form itself.

FIG. 3 illustrates an exemplary template trend indicative display form 300 for use in a care unit to display acquired vital sign patient parameters. The form is an initial or default form customizable by a user to meet particular parameter display requirements of different care units and is presented in an image together with a toolbar option menu 305 (supporting selection of Setup, Edit and Preference menus) and a selectable care unit option list 307. Default Flowsheet template form 300 named sys def (311) is hierarchically structured, using the menus of toolbar 305, as one or more pages (e.g., single page 300 in FIG. 3) containing groups (e.g., tabular group Vitals 313 and graphical group Vital Graph 315) which in turn contain parameters (e.g., HR—Heart Rate 317). A darkened background of Vitals 313 group signifies this group of parameters is activated and subject to alteration in form 300. Application 19 (FIG. 1) initiates generation of a Setup Menu supporting user determination and amendment of multiple pages, groups, and parameters via the Setup command option of toolbar 305.

Application 19 automatically dynamically expands or reduces groups of parameters to ensure parameters of interest are presented in a Flowsheet and that non-critical information is omitted in order to reduce Flowsheet clutter and enhance Flowsheet presentation clarity. This is done in response to predetermined display configuration attributes as well as the determined type of parameters acquired for display. In other embodiments, the Flowsheet display format may be dynamically configured in response to either the predetermined display configuration attributes or the determined type of acquired parameters. Data items associated with a patient parameter that may be displayed in a Flowsheet include, a volume of patient fluid infusion or output, a rate of volume of patient fluid infusion or output, a blood bank identification number, a blood type identifier, a dosage indicator, an indicator of a drip medication, an intra-venous fluid type identifier, a site on a patient associated with said patient parameter or a healthcare worker identifier, for example.

Toolbar option menu 305 is usable for selection of Setup, Edit and Preference menu functions. These functions may alternatively be initiated in response to user selection of Flowsheet data fields (such as via menus associated with data fields initiated using a right click mouse command on a selected data field, for example). A task specific popup menu is generated in response to user selection of a displayed menu item. Particular tasks in the Edit menu (initiated via toolbar 305) are completed immediately. (e.g., such as a delete group task). Further, a preview Flowsheet is updated immediately upon user acceptance of entered configuration data enabling a user to see the effect of the entered data. In addition, using the setup menus, a Flowsheet may be configured to enable seamlessly scrolling through data for an entire patient length of stay and presenting patient data in a format that a healthcare worker used to record it. Intelligent attributes and parameter groups, set using the Setup menu, add required flexibility to a Flowsheet display image while eliminating the need to customize the setup for each patient.

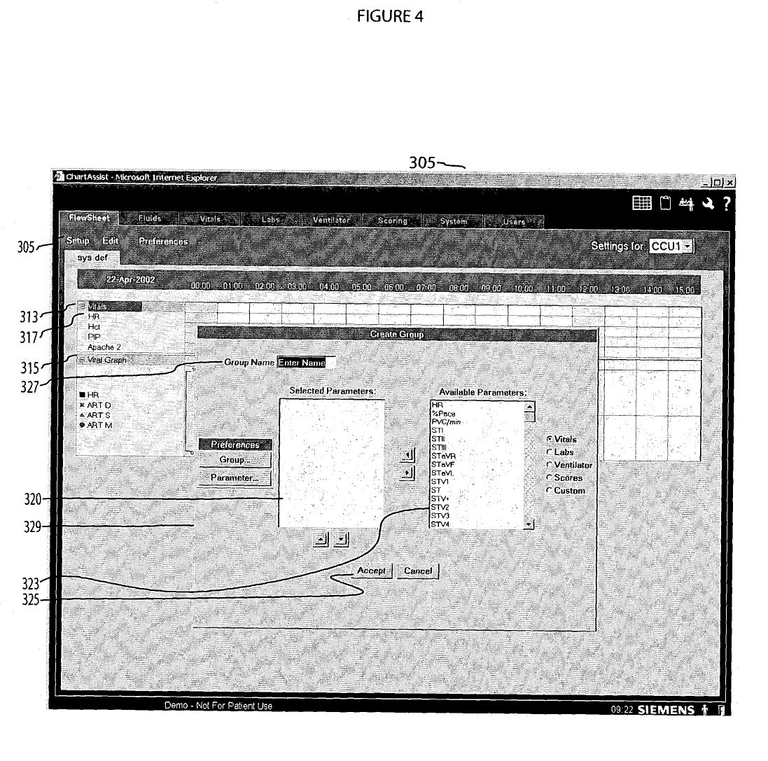

Application 19 initiates display of popup menu 329 of FIG. 4 in response to user selection of a create group menu option within the setup menu of toolbar 305. Popup menu 329 is used to determine Flowsheet configuration data by enabling a user to select attributes for different Flowsheet hierarchical objects comprising pages, groups and parameters as previously discussed (a Flowsheet may comprise multiple pages). Further, particular attributes may be applied to multiple Flowsheets that are associated with a particular care unit. Attributes selectable by a user to apply to multiple Flowsheets associated with a particular care unit include, a start time of a working day, a healthcare worker shift length, a default acquisition time interval and an indicator identifying that manual validation of a particular parameter or data item is required. Attributes selectable by a user to apply to an individual Flowsheet include Flowsheet name, position of items in a Flowsheet, and whether medications and drip parameters are to be included. Also a user is able to select attributes applicable to a particular parameter group including, indicators identifying parameters in a group as being for tabular or graphical display in a Flowsheet. A user is further able to select other settings for configuring characteristics of a graphical display of a parameter. Further, a user is able to select individual parameter attributes for determining that, particular acquired parameter representative values may be edited or that a particular parameter is always displayed. Other attributes determine that particular parameter values are to be pre-validated by a user prior to display or determine various settings for a graphical display.

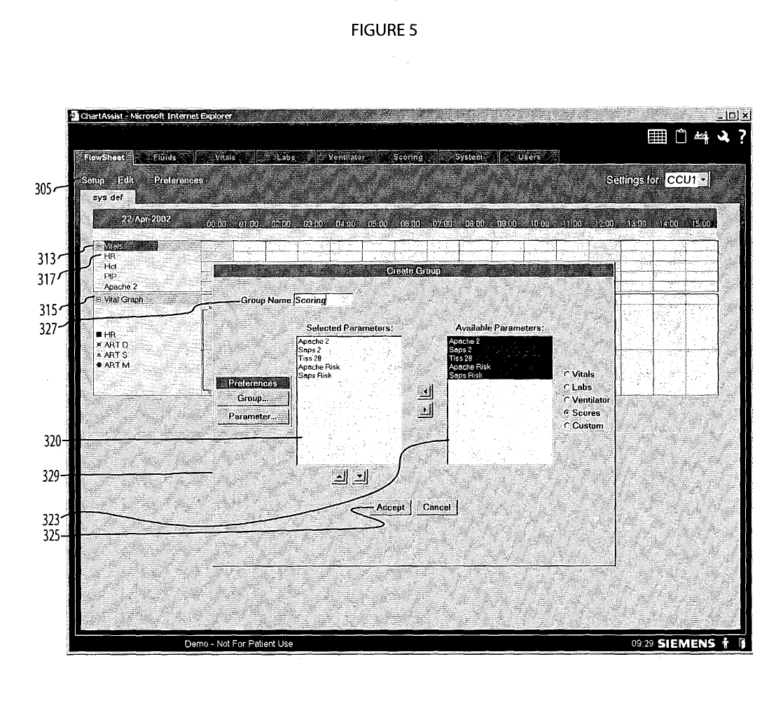

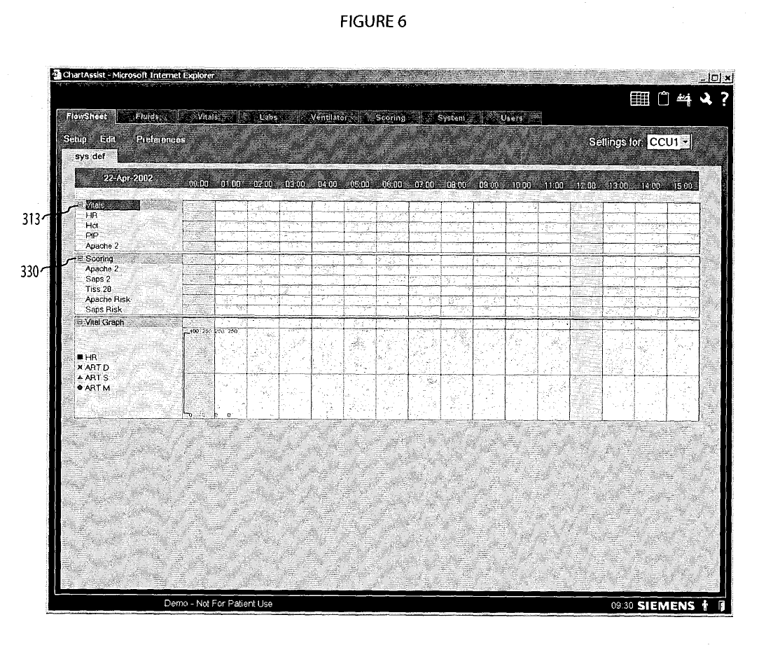

Popup menu 329 (FIG. 4) supports user determination of a group of parameters (such as Vitals group 313, for example) for display in a Flowsheet. Menu 329 is used to select particular parameters from available parameters in menu list 323 for insertion in menu box 320 to comprise a new group and to name the new group via character entry in box 327. A user may accept a particular selection or cancel the selection using buttons of bar 325. Popup menu 329 shown in FIG. 5 illustrates a user created group (named scoring in item 327) comprising user selected scoring parameters shown in box 320. In response to user entry of a group of parameters by selecting the accept button of bar 325, application 19 automatically initiates generation of data representing an updated template form for user preview. FIG. 6 shows an updated template form including tabular scoring parameter group 330 for user preview that is automatically and immediately generated in response to user acceptance of the tabular scoring parameter group of FIG. 5. A user thereby advantageously and immediately sees the effect of entering configuration data on a Flowsheet display format. FIG. 6 shows that the added group is tabular and located below active Vitals group 313, for example. A newly added group in this embodiment is positioned immediately below an active group.

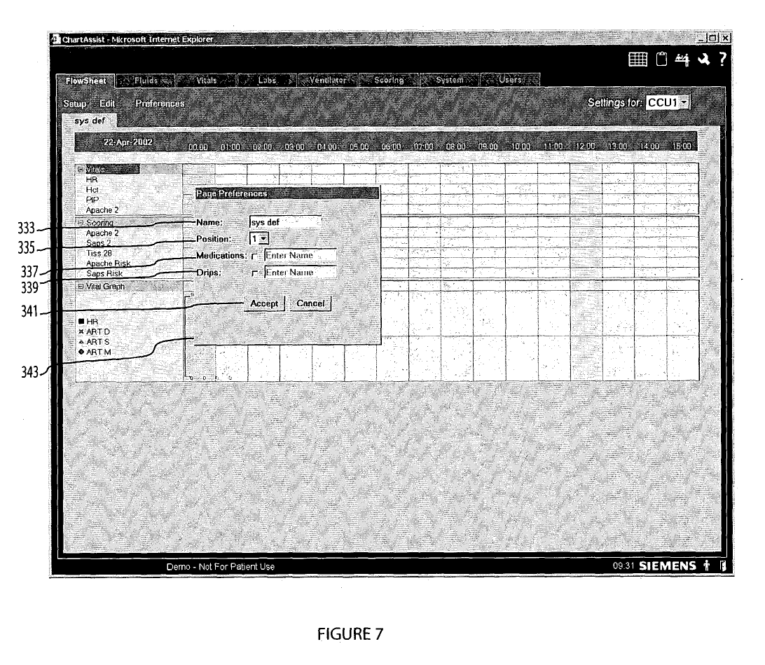

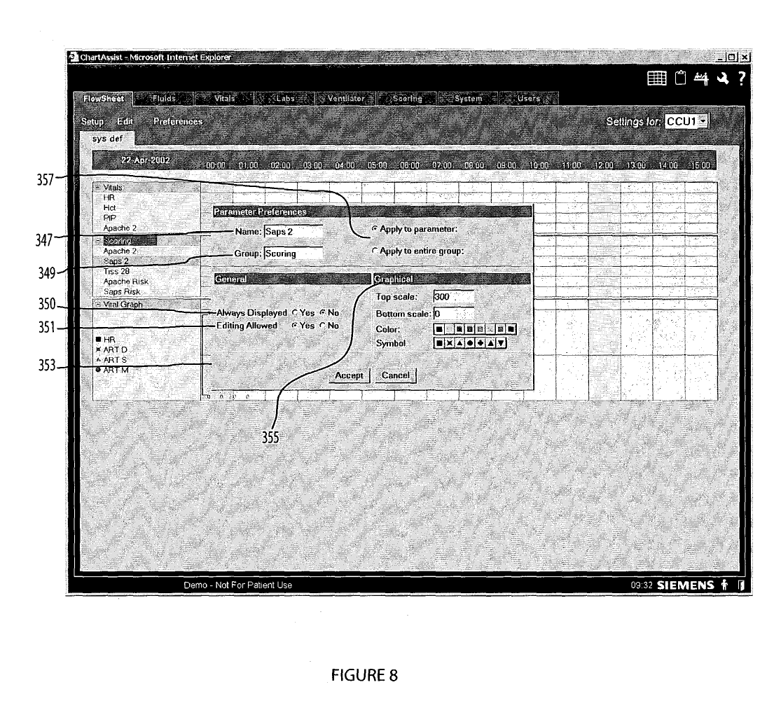

Application 19 initiates display of popup menu 343 of FIG. 7 in response to user selection of an option initiated via the setup menu of toolbar 305 (FIG. 3). The setup template is largely fixed for a particular patient to maintain as far as possible a consistent look for patient records. However, some flexibility in the way data is displayed is desirable so that a healthcare worker is able to see important information for a particular patient in a Flowsheet without excessive scrolling. This flexibility is achieved through use of the previously described group mechanism as well as through attributes (such as an always displayed attribute discussed in connection with FIG. 8) that are applied to parameters. Popup menu 343 enables a user to add a medication parameter or drip parameter group to a Flowsheet template form named in box 333. These groups enable a Flowsheet to be customized for a particular patient. Medication and drip parameter groups are incorporated in a template Flowsheet form by user selection of check boxes and entry of names using items 337 and 339 respectively. Upon user selection of a checkbox and entry of a name, an empty group with the medication or drip parameter group name is presented in a Flowsheet preview image at a columnar position located with respect to an active group (such as Vitals group 313 of FIG. 3, for example) determined via user selection of position indicator 335. A user accepts or cancels configuration data entered using popup menu 343 via displayed buttons of bar 341.

Particular medication or drip group parameters are not selected for incorporation in the Flowsheet template form at the initial template configuration stage. Such parameters are patient specific and are added at a later stage on an individual patient basis to customize the Flowsheet template form for an individual patient. Application 19 also initiates generation of popup menus to support selection and incorporation of patient specific medication or drip parameters in the medication or drip groups as required for a particular patient Following selection of a medication or drip parameter for a particular patient, a new row is automatically incorporated in the appropriate medication or drip group within the Flowsheet form of the particular patient. The new row is automatically labeled with the medication or drip parameter name and the associated rate or dosage of the parameter is also automatically entered into the Flowsheet format data fields.

Application 19 initiates display of popup menu 353 of FIG. 8 in response to user selection of an option initiated via the setup menu of toolbar 305 (FIG. 3). Popup menu 353 supports a user in configuring display of patient parameters in a group identified by items 347 and 349 within a template Flowsheet form. Specifically, menu 353 supports user selection of settings altering formatting of a template form and indicators identifying whether acquired patient parameter information is to be displayed in a template form. A user selects whether the configuration data entered using menu 353 applies to patient parameters or groups by selecting checkbox items 357. A user is able to determine settings altering formatting of a template form in menu section 355. Specifically a user, via section 355, is able to select graphical trend indicative display settings determining graph color, trend line symbols and scale. A user is also able to select an indicator (Always Displayed attribute 350) identifying that an acquired patient parameter is to be displayed in a template form. If indicator 350 is disabled, an acquired patient parameter is displayed in a Flowsheet if data representing the acquired patient parameter has been received via the network of FIG. 1. If data is not received, the template form is advantageously adaptively and automatically altered to omit the parameter row or rows (corresponding to an individual parameter or group of parameters) that are available to accommodate the parameter data from the Flowsheet. This reduces Flowsheet clutter and makes space available for display of other important parameter data. This enables a user to configure a Flowsheet to maximize space available for important information by minimizing groups that have less relevance for a given patient. If indicator 350 is enabled, data representing an acquired patient parameter is always displayed so that manually collected data is recorded in the Flowsheet if and when it is manually entered by a healthcare worker, for example. Selection of indicator 351 enables a user to specify whether a particular parameter may be edited or not. A user accepts or cancels configuration data entered using popup menu 353 via displayed buttons.

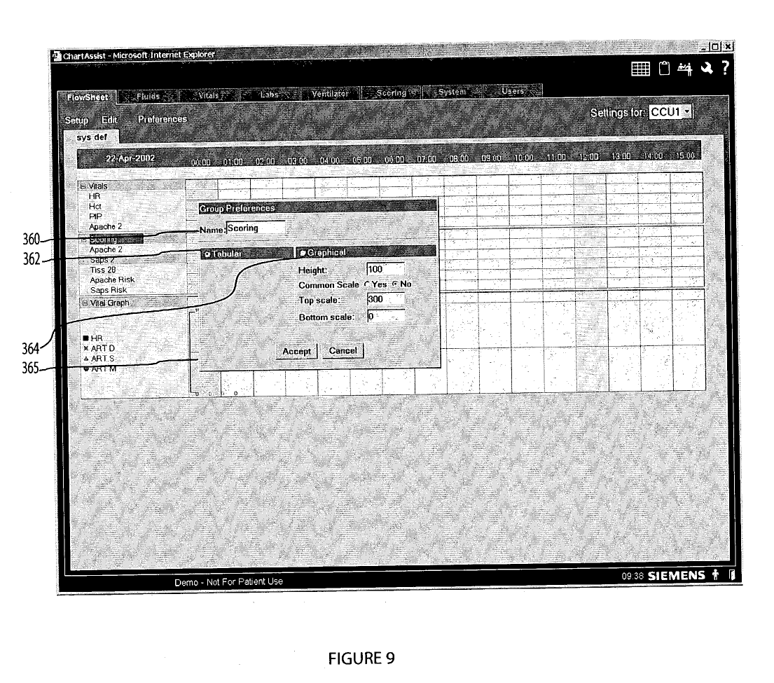

Application 19 initiates display of popup menu 365 of FIG. 9 in response to user selection of an option initiated via the setup menu of toolbar 305 (FIG. 3). Popup menu 365 enables a user to select whether a previously created group of parameters identified in box 360 is to be displayed in Tabular display format via item 362 or Graphical display format via item 364. If a user selects Graphical display format a user is further able to determine height and scaling attributes in menu 365. A user accepts or cancels configuration data entered using popup menu 365 via displayed buttons.

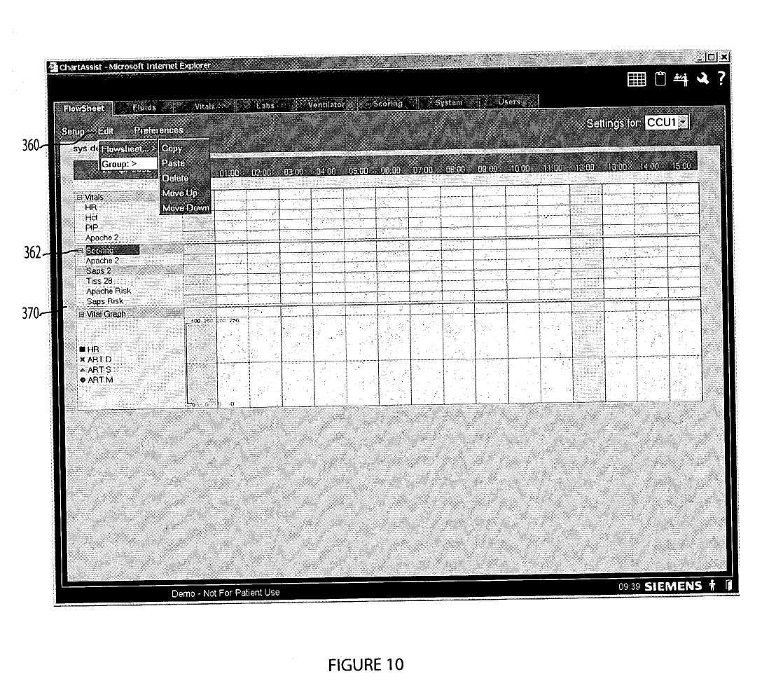

Application 19 initiates display of a template Flowsheet form 370 of FIG. 10 in response to user selection of an option initiated via the Setup menu of toolbar 305 (FIG. 3). A user is able to re-position, copy, delete and move items from selected Flowsheet 370 such as Scoring parameter group 362 (or an entire page or individual items in a page, for example) and to paste selected items into a desired Flowsheet form using Flowsheet edit functions selected using Edit option 360. Thereby Flowsheet pages and groups are copied for use in different Flowsheet forms employed within different care units.

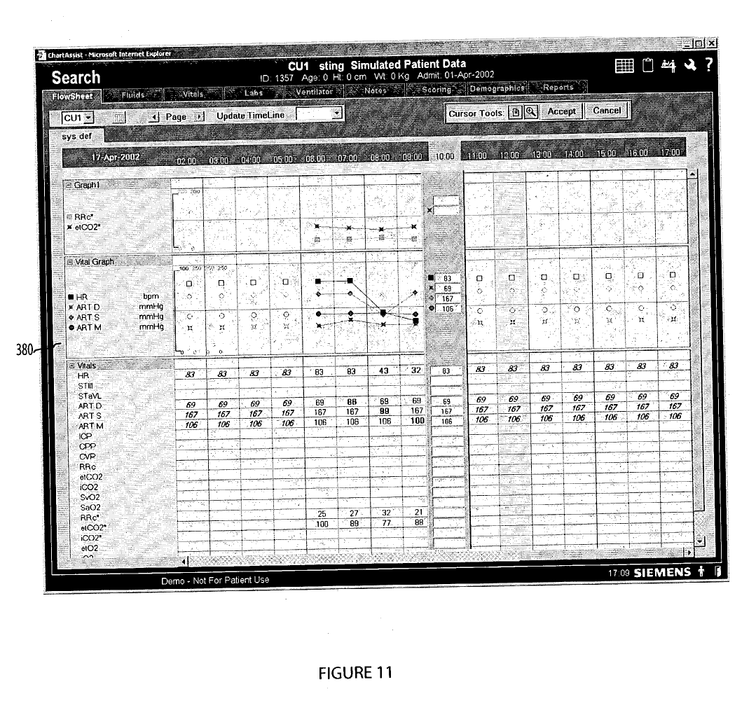

Returning to the flowchart of FIG. 12, application 19 in step 227, initiates generation of image data representing a configured Flowsheet trend indicative display of patient parameters acquired in step 223. Specifically, application 19 provides a trend indicative display form (previously created and previewed in a similar manner to the form of FIG. 6) including acquired patient parameters illustrated in FIG. 11. The process of FIG. 12 ends at step 231.

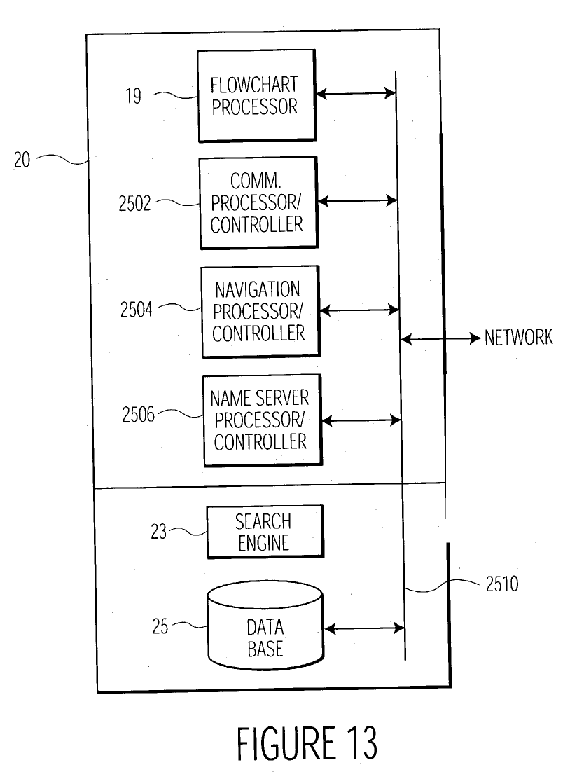

FIG. 13 shows a block diagram of an exemplary embodiment of server 20 (FIG. 1) including functions in accordance with the present invention for generating data for configuring and presenting a Flowsheet trend indicative display and for managing, collating, searching and updating data base 25 containing patient medical information. Executable applications or processors operative to carry out instructions for performing the various functions described herein include an executable application 19 for performing Flowchart related processing and communications processing module 2502 that acquires the patient data including the monitored parameters allocated to a given patient from the network and collates the information for storage in data base 25. Navigation collation processor 2504 operates in conjunction with the web browser and display generator software to collate and prioritize parameters for display to the user while navigating through various applications selected by a user through the user interface. Name server processor 2506 associates unique identifiers (IDs) with each node connected to the system network and with each patient in the system in order to track and update patient information throughout the system. Input/output data and control signals are used to communicate between the various processors as well as to interface with the data base 25 and search engine 23 and with the network via communication line 2510.

The Flowchart user interface display images, systems and processes presented in FIGS. 1-13 are not exclusive. Other Flowchart configuration and presentation display images, systems and processes may be derived in accordance with the principles of the invention to accomplish the same objectives. Although this invention has been described with reference to particular embodiments, it is to be understood that the embodiments and variations shown and described herein are for illustration only and that various modifications may be implemented by those skilled in the art without departing from the scope of the invention. Flowchart user interface functions supporting flexible, user friendly, Flowchart configuration and presentation formats may be used in any application where different users desire data to be displayed in corresponding different ways.

What is claimed is:

1. A system for providing a user interface presenting patient medical parameter data in a trend indicative display indicating a time period comprising patient parameter acquisition time intervals, comprising:
an acquisition processor for acquiring, from a patient monitoring device, data representing a parameter of a particular patient;
a selection processor for selecting a template display form from a predetermined plurality of template display forms associated with a corresponding plurality of different care units in response to a determined type of said acquired patient parameter; and
a data processor for generating data representing a trend indicative display of said acquired patient parameter within said selected template display form.

2. A user interface system according to claim 1, wherein
said selection processor identifies a care unit of said plurality of different care units based on said determined type of said acquired patient parameter and selects a form associated with said particular patient from a plurality of forms associated with said identified care unit.

3. A user interface system according to claim 2, wherein
said selection processor automatically selects said form associated with said particular patient from a plurality of forms associated with said identified care unit using a patient identifier.

4. A user interface system according to claim 1, wherein
said acquisition processor acquires, from a patient monitoring device, data representing a plurality of parameters of said particular patient and
said selection processor identifies a care unit of said plurality of different care units based on a determined type of said acquired plurality of patient parameters.

5. A user interface system according to claim 1, wherein
said selection processor determines a type of said acquired patient parameter from types including at least two of, (a) a blood pressure parameter, (b) a ventilation parameter, (c) a vital sign parameter, (d) a blood oxygen concentration representative parameter, (e) an infusion pump parameter associated with fluid delivery, (f) a drip medication related parameter and (g) another fluid related parameter.

6. A user interface system according to claim 1, wherein
said plurality of different care units comprise hospital departments including at least two of, (a) an intensive care unit, (b) a critical care unit, (c) a surgical unit, (d) an examination unit, (e) a physiotherapy unit, (f) an emergency unit, (g) an imaging unit, (h) an obstetrics/gynecology unit, (i) a pediatric unit, (j) a preventive care unit and (k) a radiology unit.

7. A user interface system according to claim 1, wherein
said selection processor determines a type of said acquired patient parameter from at least one of, (a) message data associated with said particular patient parameter, (b) a characteristic of a signal conveying said acquired patient parameter, (c) a characteristic of said acquired patient parameter and (d) data identifying a source of said acquired patient parameter.

8. A user interface system according to claim 1, wherein
said data processor adaptively modifies said selected template display form in response to a predetermined attribute associated with said acquired patient parameter and generates data representing a trend indicative display of said acquired patient parameter within said modified template display form.

9. A user interface system according to claim 8, wherein
said predetermined attribute associated with said acquired patient parameter at least one of, (a) identifies whether said acquired patient parameter data is to be displayed, (b) determines display settings of said trend indicative display and (c) identifies said care unit of said plurality of different care units, (d) identifies a particular patient and associates a predetermined trend indicative display format characteristic with said particular patient and (e) identifies a time period comprising patient parameter acquisition time intervals to be used by said trend indicative display format.

10. A system for providing a user interface presenting patient medical parameter data in a trend indicative display indicating a time period comprising patient parameter acquisition time intervals, comprising:
an interface processor for acquiring,
data representing a parameter of a particular patient from a patient monitoring device,
information identifying a care unit associated with said acquired patient parameter data and
an identifier identifying said particular patient;
a selection processor for selecting a template display form from a predetermined plurality of template display forms associated with a corresponding plurality of different care units in response to said information identifying said care unit; and
a processor for initiating generation of data representing a trend indicative display of said acquired patient parameter within said selected template display form.

11. A user interface system according to claim 10, wherein
said selection processor automatically selects said form associated with said particular patient from a plurality of forms associated with said identified care unit using a patient identifier.

12. A system for providing a user interface presenting patient medical parameter data in a trend indicative display indicating a time period comprising patient parameter acquisition time intervals, comprising:
an acquisition processor for acquiring, from a patient monitoring device, data representing a parameter of a particular patient;
a selection processor for selecting a template display form from a predetermined plurality of template display forms associated with a corresponding plurality of different care units in response to information identifying a care unit source of said acquired patient parameter; and
a data processor for adaptively modifying said selected template display form in response to a format indicator and generating data representing a trend indicative display of said acquired patient parameter within said modified template display form.

13. A user interface system according to claim 12, wherein
said format indicator comprises data for at least one of, (a) identifying whether said acquired patient parameter data is to be displayed, (b) determining display settings of said trend indicative display, (c) information identifying said care unit of said plurality of different care units and associating a predetermined trend indicative display format characteristic with said care unit, (d) information identifying a particular patient and associating a predetermined trend indicative display format characteristic with said particular patient and (e) information identifying a time period comprising patient parameter acquisition time intervals to be used by said trend indicative display format.

14. A system for configuring a user interface form for presenting patient medical parameter data in a trend indicative display indicating a time period comprising patient parameter acquisition time intervals, comprising:
a processor for initiating, in response to user command, generation of data representing at least one display image comprising,
a template form for use in presenting acquired patient medical parameter data in a trend indicative display, and
an image window supporting configuration of said template form by user selection of configuration data including at least one of, (a) settings altering formatting of said template form, (b) parameters for inclusion in said template form and (c) indicators identifying whether acquired patient parameter information is to be displayed in said template form; and
a command processor for automatically initiating generation of data representing an updated template form for user preview in response to user selection of said configuration data.

15. A user interface system according to claim 14, wherein
said template form is selected from a predetermined plurality of template display forms associated with a corresponding plurality of different care units in response to said information identifying said care unit.

16. A user interface system according to claim 14, wherein
said template form and said image window are presented in a single composite image.

17. A user interface system according to claim 14, wherein
said updated template form is automatically presented to a user in response to user selection of said configuration data to permit a user to determine whether to accept or decline use of said selected configuration data

18. A user interface system according to claim 14, wherein
said image window supports user selection of configuration data including data for at least one of, (i) information identifying said care unit of said plurality of different care units and associating a predetermined trend indicative display format characteristic with said care unit, (ii) information identifying a particular patient and associating a predetermined trend indicative display format characteristic with said particular patient, (iii) information identifying a time period comprising patient parameter acquisition time intervals to be used by said trend indicative display format and (iv) a name for identifying a configured template form.

19. A user interface system according to claim 14, wherein
said image window supports user selection of configuration data including data for organizing parameters into an identified group.

20. A user interface system according to claim 14, wherein
said image window supports user selection of configuration data including data for at least one of, (a) copying a form from a file associated with a first care unit to comprise said template form, (b) copying said settings from a file associated with a first care unit, (c) deleting said settings, (d) repositioning images comprising said template form, (e) deleting images comprising said template form.

21. A user interface system according to claim 14, including
an acquisition processor for acquiring, from a patient monitoring device, said acquired patient medical parameter data.

22. A user interface system according to claim 14, wherein
said image window supports user selection of configuration data associating a patient parameter with a property indicating at least one of, (a) said data item represents volume data to be used in patient fluid infusion or output calculation, (b) said data item represents a rate for use in calculation of volume of patient fluid infusion or output and (c) said data item value is to be used in multiple acquisition time intervals of said trend indicative display.
